(19) United States
(12) Patent Application Publication
(10) Pub. No.: US 2017/0012356 A1
(43) Pub. Date: Jan. 12, 2017

(54) PRINTED MULTI-BAND ANTENNA

(71) Applicant: ARCADYAN TECHNOLOGY CORPORATION, Hsinchu City (TW)

(72) Inventors: CHIH-YUNG HUANG, Hsinchu City (TW); KUO-CHANG LO, Hsinchu City (TW)

(21) Appl. No.: 14/925,145

(22) Filed: Oct. 28, 2015

(30) Foreign Application Priority Data
Jul. 7, 2015 (TW) 104122073

(51) Int. Cl. H01Q 9/04; H01Q 1/38

(52) U.S. Cl. CPC H01Q 9/04; H01Q 1/38

(57) ABSTRACT

A printed multi-band antenna is provided, which may include a grounding area, a first radiating body and a second radiating body. The grounding area may connect to the grounding layer of a RF cable connecting to a RF signal module. The first radiating body may connect to the grounding area and include a first left branch and a first right branch.

The first left branch may be at one side of the joint of the RF cable and the grounding area; the first right branch may be at the opposite side. The second radiating body may connect to the signal wire of the RF cable, and include a second left branch and a second right branch. The second left branch may be at one side of the joint of the RF cable, and the second radiating body and the second right branch may be at the opposite side.

### CROSS-REFERENCE TO RELATED APPLICATION

This application claims the benefit of Taiwan Patent Application No. 104122073, filed on Jul. 7, 2015, in the Taiwan Intellectual Property Office, the disclosure of which is incorporated herein in its entirety by reference.

### BACKGROUND OF THE INVENTION

1. Field of the Invention

The present invention generally relates to a movable touch device and an electronic device thereof, in particular to a detachable movable touch device and an electronic device thereof.

2. Description of the Related Art

Currently, as mobile devices are necessary for people's daily life, so the communication industry is getting rapid development; therefore, various compact antennas are developed and comprehensively applied to a variety of mobile devices, such as planar inverse-F antenna, monopole antenna and the like. However, the conventional antennas still have a lot of shortcomings to be overcome.

For instance, the structure of planar inverse-F antenna is very complicated; besides, planar inverse-F antenna is an antenna with 3D structure, so it needs additional mold cost and assembly cost; therefore, the manufacturing cost of planar inverse-F antenna is significantly increased due to the above factors, so its commercial competitiveness is decreased. In addition, the bandwidth of planar inverse-F antenna is very narrow and which cannot be easily adjusted according to different requirements; accordingly, its application is also limited.

Therefore, it has become an important issue to provide a multi-band antenna to solve the problems that the conventional antennas are of complicated structure, high cost and inflexible in use.

### SUMMARY OF THE INVENTION

Therefore, it is a primary objective of the present invention to provide a detachable movable device and an electronic device thereof to achieve the effect of reducing the tear and wear of a touch display panel of a general electronic device.

According to one aspect of the present invention, one embodiment of the present invention provides a printed multi-band antenna, which may include a grounding area, a first radiation body and a second radiation body. The grounding area may be coupled to a grounding layer of a RF cable and the RF cable may be coupled to a RF signal module. The first radiation body may be coupled to the grounding area, wherein the first radiation body may include a first left branch and a first right branch; the first left branch may be disposed at one side of the joint between the RF cable and the grounding area; the first right branch may be disposed at the other side of the joint between the RF cable and the grounding area; a space may be formed between the first radiating body and the grounding area. The second radiation body may be disposed at the space, and may be coupled to the signal wire of the RF cable, wherein the second radiation body may include a second left branch and a second right branch; the second left branch may be disposed at one side of the joint of the RF cable and the second radiating body and the second right branch may be disposed at the other side of the joint of the RF cable and the second radiating body.

In a preferred embodiment of the present invention, the first left branch may be asymmetrical to the first right branch and the second left branch may be asymmetrical to the second right branch.

In a preferred embodiment of the present invention, the first left branch may extend vertically and/or horizontally.

In a preferred embodiment of the present invention, the first left branch may be substantially L-shaped.

In a preferred embodiment of the present invention, the first left branch may further include at least one patch, and the patch may be rectangular, circular, elliptical, trapezoid, polygonal or irregular-shaped.

In a preferred embodiment of the present invention, the patch of the first left branch may be related to the impedance matching of the first radiation body.

In a preferred embodiment of the present invention, the first right branch may extend vertically and/or horizontally.

In a preferred embodiment of the present invention, the first right branch may be substantially L-shaped.

In a preferred embodiment of the present invention, the first left branch may further include at least one patch, and the patch may be rectangular, circular, elliptical, trapezoid, polygonal or irregular-shaped.

In a preferred embodiment of the present invention, the patch of the first right branch may be disposed at an end of the first right branch and may be related to the bandwidth of the first radiation body.

In a preferred embodiment of the present invention, the length of the first right branch may be related to the operation frequency band of the first radiation body.

In a preferred embodiment of the present invention, the second right branch may extend vertically and/or horizontally.

In a preferred embodiment of the present invention, the second right branch may be substantially U-shaped.

In a preferred embodiment of the present invention, the second right branch may further include at least one patch, and the patch may be rectangular, circular, elliptical, trapezoid, polygonal or irregular-shaped.

In a preferred embodiment of the present invention, the patch of the second right branch may be disposed at the center of the second right branch and may be related to the bandwidth of the second radiation body.

In a preferred embodiment of the present invention, the length of the second right branch may be related to the operation frequency band of the second radiation body.

In a preferred embodiment of the present invention, the second left branch may extend vertically and/or horizontally.

In a preferred embodiment of the present invention, the second left branch may be substantially U-shaped.

In a preferred embodiment of the present invention, the length of the second left branch may be related to the operation frequency band of the second radiation body and the second left branch may further include at least one patch, and the patch may be rectangular, circular, elliptical, trapezoid, polygonal or irregular-shaped.

In a preferred embodiment of the present invention, the patch of the second left branch may be disposed at the end of the second left branch and may be related to the impedance matching of the second radiation body.

The printed multi-band antenna according to the present invention includes the following advantages:

(1) In one embodiment of the present invention, the impedance matching, operation frequency band and bandwidth of the printed multi-band antenna are very easy to adjust, so the printed multi-band antenna can conform to the requirements of various applications. Thus, the printed multi-band antenna is very flexible in use.

(2) In one embodiment of the present invention, the printed multi-band antenna can be directly printed on a circuit board, so the printed multi-band antenna does not need additional mold cost and assembly cost; further, the structure of the printed multi-band antenna is very simple, so the cost of the printed multi-band antenna can be lower.

(3) In one embodiment of the present invention, the printed multi-band antenna can directly feed the signals in the circuit board without additional cables, so the structure of the printed multi-band antenna can be very simple and the cost of the printed multi-band antenna can be further reduced.

(4) In one embodiment of the present invention, the printed multi-band antenna does not need the grounding end, so the size of the printed multi-band antenna can be much smaller than planar inverse-F antenna.

(5) In one embodiment of the present invention, the printed multi-band antenna can be applied to an independent circuit board, or share a circuit board with the system, so the application of the printed multi-band antenna can be more comprehensive.

### BRIEF DESCRIPTION OF THE DRAWINGS

The detailed structure, operating principle and effects of the present invention will now be described in more details hereinafter with reference to the accompanying drawings that show various embodiments of the invention as follows.

FIG. 1 is the schematic view of the first embodiment of the printed multi-band antenna in accordance with the present invention.

FIG. 2 is the schematic view of the second embodiment of the printed multi-band antenna in accordance with the present invention.

FIG. 3 is the schematic view of the third embodiment of the printed multi-band antenna in accordance with the present invention.

FIG. 4 is the schematic view of the fourth embodiment of the printed multi-band antenna in accordance with the present invention.

FIG. 5 is the schematic view of the fifth embodiment of the printed multi-band antenna in accordance with the present invention.

FIG. 6 is the schematic view of the sixth embodiment of the printed multi-band antenna in accordance with the present invention.

FIG. 7 is the first schematic view of the seventh embodiment of the printed multi-band antenna in accordance with the present invention.

FIG. 8 is the second schematic view of the seventh embodiment of the printed multi-band antenna in accordance with the present invention.

FIG. 9 is the third schematic view of the seventh embodiment of the printed multi-band antenna in accordance with the present invention.

FIG. 10 is the fourth schematic view of the seventh embodiment of the printed multi-band antenna in accordance with the present invention.

FIG. 11 is the schematic view of the eighth embodiment of the printed multi-band antenna in accordance with the present invention.

### DETAILED DESCRIPTION OF THE PREFERRED EMBODIMENTS

The technical content of the present invention will become apparent by the detailed description of the following embodiments and the illustration of related drawings as follows.

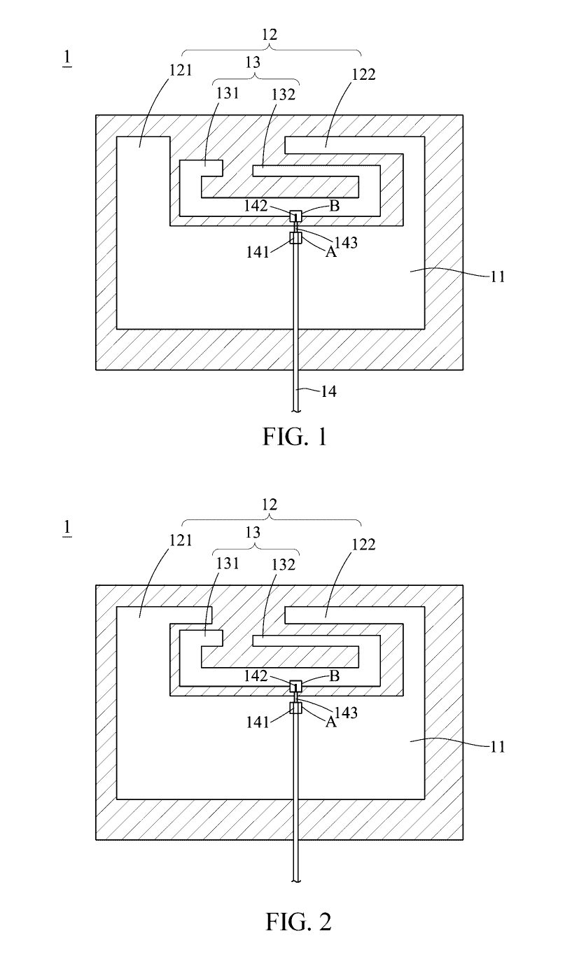

Please refer to FIG. 1, which is the schematic view of the first embodiment of the printed multi-band antenna in accordance with the present invention. As shown in FIG. 1, the printed multi-band antenna 1 is applied to a small independent circuit board, which may include a grounding area 11, a first radiation body 12 and a second radiation body 13.

The grounding area 11 may be coupled to the grounding layer 141 of a RF cable 14, and the RF cable 14 may be coupled to a RF signal module (not shown in the drawings). The first radiation body 12 may be coupled to the grounding area 11, and there is a space between the first radiation body 12 and the grounding area 11. The first radiation body 12 may include a first left branch 121 and a first right branch 122; the first left branch 121 may be disposed at one side of the joint A between the RF cable 14 and the grounding area 11; the first right branch 122 may be disposed at the other side of the joint A between the RF cable 14 and the grounding area 11; the first left branch 121 may be asymmetrical to the first right branch 122.

The second radiation body 13 may be disposed at the space between the first radiation body 12 and the grounding area 11, and the second radiation body 13 may be coupled to the signal wire 142 of the RF cable 14; the signal wire 142 may be isolated from the grounding area 11 by an isolation layer 143. The second radiation body 13 may include a second left branch 131 and a second right branch 132; the second left branch 131 may be disposed at one side of the joint B of the RF cable 14 and the second radiating body 13; the second right branch 132 may be disposed at the other side of the joint B of the RF cable 14 and the second radiating body 13; similarly, the second left branch 131 may be asymmetrical to the second right branch 132.

For the purpose of meeting various different application requirements, the working frequency band, bandwidth and impedance, etc., of the first radiation body 12 and the second radiation body 13 of the printed multi-band antenna 1 can be adjusted according to different applications. For example, the first left branch 121 and the first right branch 122 of the first radiation body 12 may selectively extend toward the vertical direction, horizontal direction or other directions, so the first radiation body 12 may have different characteristics; similarly, the second left branch 131 and the second right branch 132 of the second radiation body 13 may also selectively extend toward the vertical direction, horizontal direction or other directions, so the first radiation body 12 may also have different characteristics. Thus, the printed multi-band antenna 1 can conform to different application requirements.

More specifically, the length of the first left branch 121 may be related to the impedance of the first radiation body 12, so the length of the first left branch 121 may be adjusted to change the impedance of the first radiation body 12. The length of the first right branch 122 may be related to the operation frequency band of the first radiation body 12, so the length of the first right branch 122 may be adjusted to change the operation frequency band of the first radiation body 12. The length of the second left branch 131 may be related to the operation frequency band of the second radiation body 13, so the length of the second left branch 131 may be adjusted to change the operation frequency band of the second radiation body 13.

In the embodiment, the first left branch 121 may extend vertically, and the first right branch 122 may extend vertically and horizontally, and be L-shaped. The second left branch 131 and the second right branch 132 may extend vertically and horizontally, and be U-shaped. As described above, the first radiation body 12 and the second radiation body 13 may be adjusted to change their characteristics, so the printed multi-band antenna 1 can satisfy various different application requirements.

Please refer to FIG. 2, which is the schematic view of the second embodiment of the printed multi-band antenna in accordance with the present invention. As shown in FIG. 2, the printed multi-band antenna 1 may include a grounding area 11, a first radiation body 12 and a second radiation body 13.

Similarly, the grounding area 11 may be coupled to the grounding layer 141 of a RF cable 14, and the RF cable 14 may be coupled to a RF signal module (not shown in the drawings). The first radiation body 12 may be coupled to the grounding area 11, and there is a space between the first radiation body 12 and the grounding area 11. The first radiation body 12 may include a first left branch 121 and a first right branch 122; the first left branch 121 may be disposed at one side of the joint A between the RF cable 14 and the grounding area 11; the first right branch 122 may be disposed at the other side of the joint A between the RF cable 14 and the grounding area 11; the first left branch 121 may be asymmetrical to the first right branch 122. The second radiation body 13 may be disposed at the space between the first radiation body 12 and the grounding area 11, and the second radiation body 13 may be coupled to the signal wire 142 of the RF cable 14; the signal wire 142 may be isolated from the grounding area 11 by an isolation layer 143. The second radiation body 13 may include a second left branch 131 and a second right branch 132; the second left branch 131 may be disposed at one side of the joint B of the RF cable 14 and the second radiating body 13; the second right branch 132 may be disposed at the other side of the joint B of the RF cable 14 and the second radiating body 13; similarly, the second left branch 131 may be asymmetrical to the second right branch 132.

The difference between the embodiment and the previous embodiment is that the first left branch 121 and the first right branch 122 may extend vertically and horizontally, and be L-shaped; besides, the second left branch 131 and the second right branch 132 may extend vertically and horizontally, and be U-shaped. The above arrangement allows the first radiation body 12 and the second radiation body 13 to have different characteristics, so the printed multi-band antenna 1 can satisfy different application requirements.

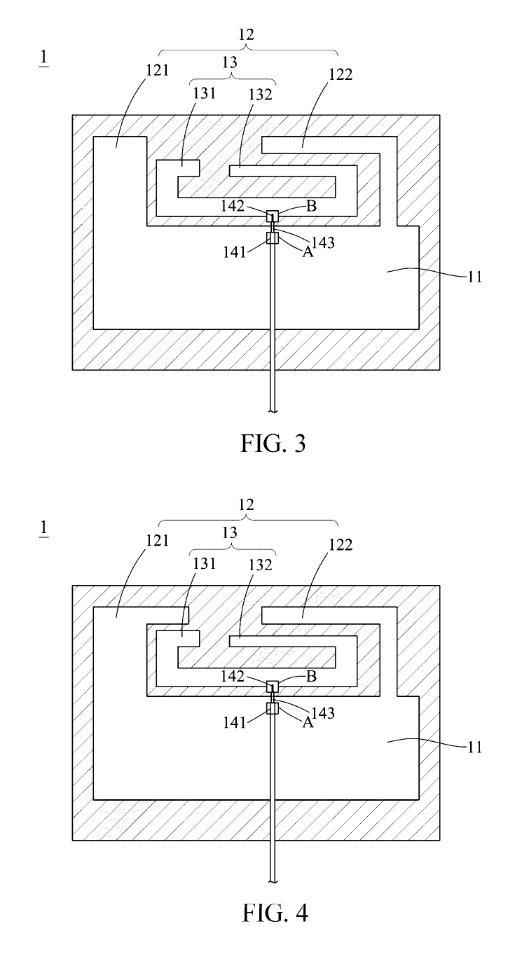

Please refer to FIG. 3, which is the schematic view of the third embodiment of the printed multi-band antenna in accordance with the present invention. As shown in FIG. 3, the printed multi-band antenna 1 may include a grounding area 11, a first radiation body 12 and a second radiation body 13.

The difference between the embodiment and the previous embodiment is that the first left branch 121 may extend vertically and horizontally; the first right branch 122 may extend vertically and horizontally and be L-shaped; besides, the second left branch 131 and the second right branch 132 may extend vertically and horizontally, and be U-shaped; the grounding area 11 may protrude from the printed multi-band antenna 1. The above arrangement allows the first radiation body 12 and the second radiation body 13 to have different characteristics, so the printed multi-band antenna 1 can satisfy different application requirements.

Please refer to FIG. 4, which is the schematic view of the fourth embodiment of the printed multi-band antenna in accordance with the present invention. As shown in FIG. 4, the printed multi-band antenna 1 may include a grounding area 11, a first radiation body 12 and a second radiation body 13.

The difference between the embodiment and the previous embodiment is that the first left branch 121 and the first right branch 122 may extend vertically and horizontally, and be L-shaped; besides, the second left branch 131 and the second right branch 132 may extend vertically and horizontally, and be U-shaped; the grounding area 11 may protrude from the printed multi-band antenna 1. The above arrangement allows the first radiation body 12 and the second radiation body 13 to have different characteristics, so the printed multi-band antenna 1 can satisfy different application requirements.

Please refer to FIG. 5, which is the schematic view of the fifth embodiment of the printed multi-band antenna in accordance with the present invention. As shown in FIG. 5, the printed multi-band antenna 1 may include a grounding area 11, a first radiation body 12 and a second radiation body 13.

The difference between the embodiment and the previous embodiment is that the first left branch 121 and the first right branch 122 may extend vertically and horizontally, and be L-shaped; the extension length of the first left branch 121 may be longer than that of the first right branch 122; besides, the second left branch 131 and the second right branch 132 may extend vertically and horizontally, and be U-shaped; the extension length of the second left branch 131 may be longer than that of the second right branch 132; the grounding area 11 may protrude from the printed multi-band antenna 1. The above arrangement allows the first radiation body 12 and the second radiation body 13 to have different characteristics, so the printed multi-band antenna 1 can satisfy different application requirements.

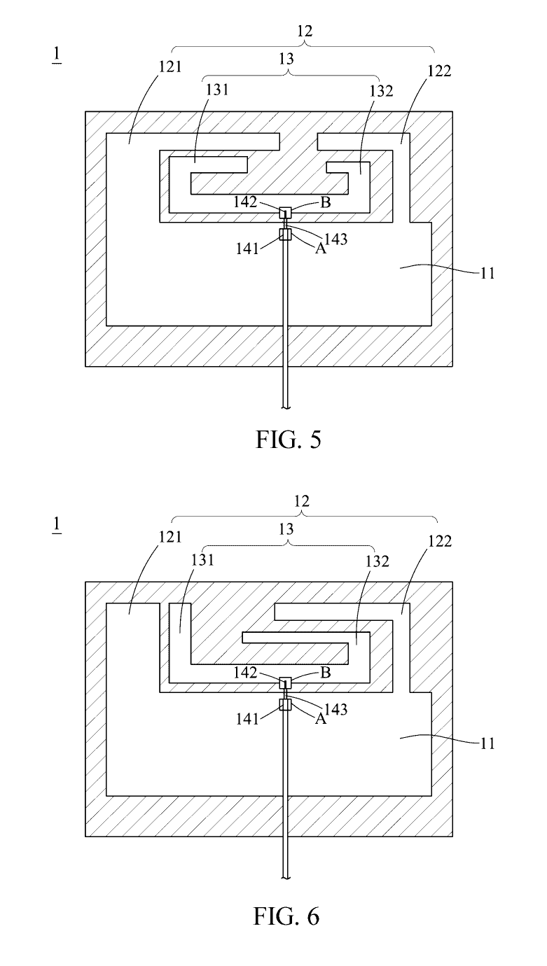

Please refer to FIG. 6, which is the schematic view of the sixth embodiment of the printed multi-band antenna in accordance with the present invention. As shown in FIG. 6, the printed multi-band antenna 1 may include a grounding area 11, a first radiation body 12 and a second radiation body 13.

The difference between the embodiment and the previous embodiment is that the first left branch 121 may extend vertically, and the first right branch 122 may extend vertically and horizontally, and be L-shaped; besides, the second right branch 132 may extend vertically and horizontally, and be U-shaped; the grounding area 11 may protrude from the printed multi-band antenna 1. The above arrangement allows the first radiation body 12 and the second radiation body 13 to have different characteristics, so the printed multi-band antenna 1 can satisfy different application requirements.

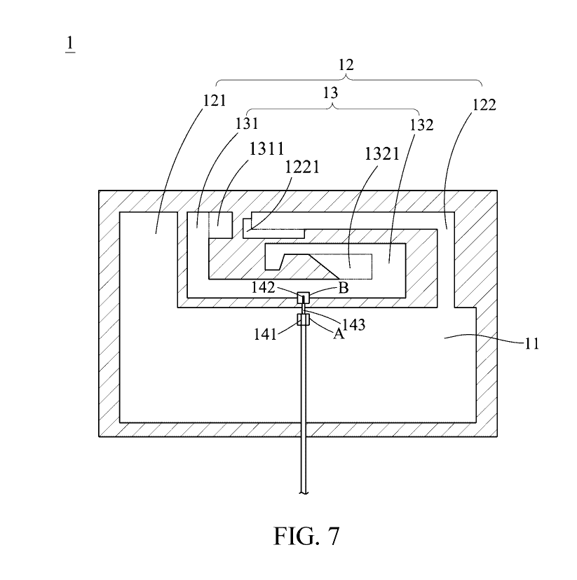

Please refer to FIG. 7, which is the schematic view of the seventh embodiment of the printed multi-band antenna in accordance with the present invention. As shown in FIG. 7, the printed multi-band antenna 1 may include a grounding area 11, a first radiation body 12 and a second radiation body 13.

The difference between the embodiment and the previous embodiment is that the first left branch 121 may extend vertically, and the first right branch 122 may extend vertically and horizontally, and be L-shaped. The first right branch 122 may further include a patch 1211, which may be disposed at the end of the first right branch 122 and be related to the bandwidth of the first radiation body 12. The second left branch 131 may extend vertically and the vertical extension length of the second left branch 131 may be longer than that of the second right branch 132; in addition, the second left branch 131 may further include a patch 1311, which may be disposed at the end of the second left branch 131 and be related to the impedance of the second radiation body 13; the second left branch 131 may extend vertically and the vertical extension length of the second left branch 131 may be longer than that of the second right branch 132. The second right branch 132 may extend vertically and horizontally, and the second right branch 132 may include a patch 1321, which may be disposed at the center of the second right branch 132 and be related to the bandwidth of the second radiation body 13. The above arrangement allows the first radiation body 12 and the second radiation body 13 to have different characteristics, so the printed multi-band antenna 1 can satisfy different application requirements. The aforementioned patches 1221, 1311 and 1321 may have different shapes according to different requirements, such as rectangular, circular, elliptical, trapezoid, polygonal or irregular-shaped, etc.

As described above, the printed multi-band antenna 1 may be adjusted according to the above embodiments to allow the first radiation body 12 and the second radiation body 13 to have different characteristics; in this way, the printed multi-band antenna 1 can be applied to different frequency bands, such as LTE-Bands (824-894 MHz), LTE-Band20 (791-892 MHz), LTE-Band1 (1920-2170 MHz), LTE-Band3 (1710-1880 MHz), LTE-Band4 (1710-2155 MHz). 3G-Band (860-960 MHz), UMTS (1920-2170 MHz), LTE-Band40 (2300-2400 MHz) and LTE-Band1 (2500-2690 MHz), etc. Thus, the printed multi-band antenna 1 is very suitable to be applied to various electric devices, such as notebook computer, mobile phone, access point and TV with WIFI function, etc.

It is worthy to point out that the operation frequency band, bandwidth and impedance, etc., of the conventional antennas cannot be easily adjusted; thus, the conventional antennas cannot satisfy different application requirements. On the contrary, according to the embodiments of the present invention, the branches of the first radiation body and the second radiation body of the printed multi-band antenna can extend toward different directions to achieve proper resonant lengths; in addition, patches with different shapes can be added to the antenna to flexibly adjust its operation frequency band, bandwidth and impedance, etc., so the antenna can satisfy different application requirements. Accordingly, compared with the conventional antennas, the printed multi-band antenna according to the embodiments of the present invention is more flexible in use and its application can be more comprehensive.

Also, as the conventional antennas, such as planar inverse-F antenna, are 3D antennas, so the conventional antennas need additional mold cost and assembly cost. On the contrary, the printed multi-band antenna according to the embodiments of the present invention can be directly printed on a circuit board, so the additional mold coat and assembly cost can be saved; besides, the printed multi-band antenna is of simple structure, so its cost can be lower. Accordingly, the cost of the printed multi-band antenna according to the embodiments of the present invention can be further reduced, so the antenna can have higher commercial competitiveness.

Moreover, as the conventional antennas, such as planar inverse-F antenna, need additional grounding end, so the size of the conventional antennas cannot be further reduced. On the contrary, the printed multi-band antenna according to the embodiments of the present invention does not need additional grounding end, so the size of the printed multi-band antenna can be smaller than that of the planar inverse-F antenna. Thus, the application of the printed multi-band antenna according to the embodiments of the present invention can be more comprehensive. As described above, the present invention definitely has an inventive step.

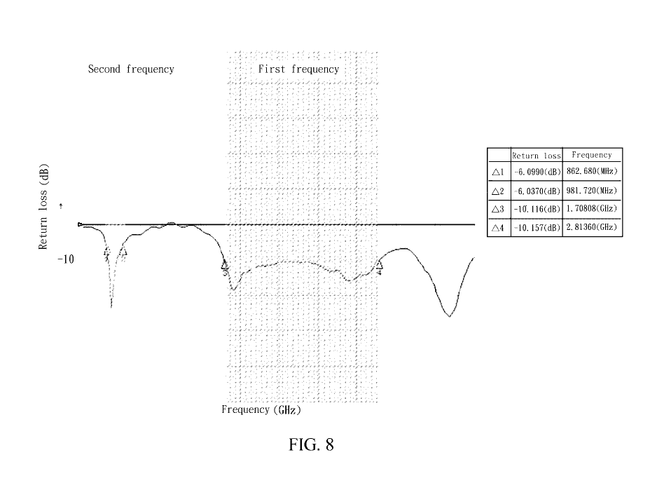

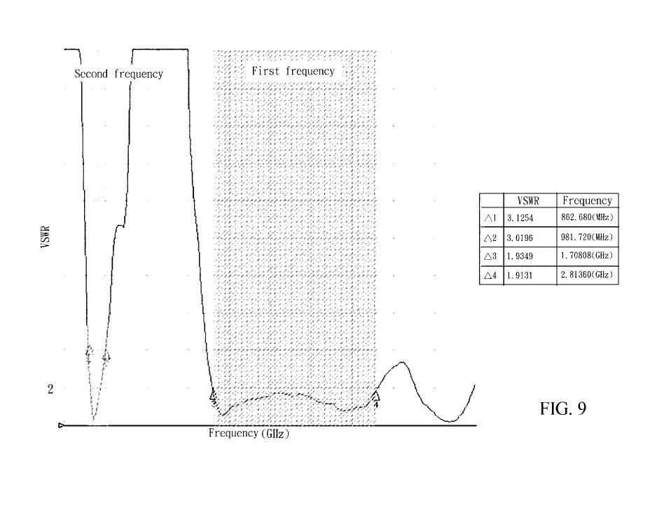

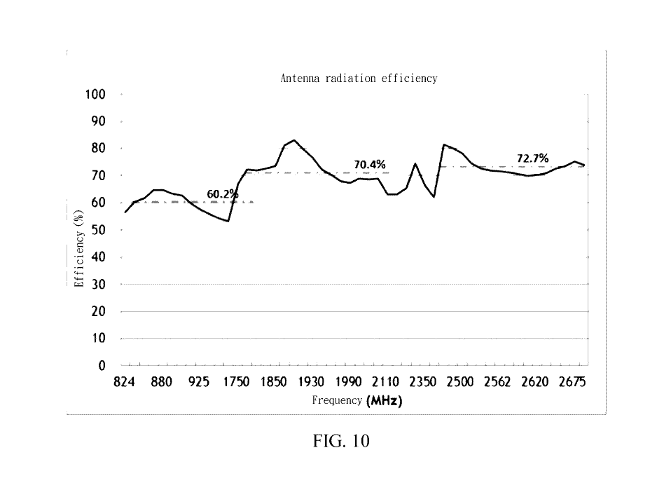

Please refer to FIG. 8, FIG. 9 and FIG. 10, which is the second schematic view, third schematic view and the fourth schematic view of the seventh embodiment of the printed multi-band antenna in accordance with the present invention. FIG. 8 illustrates the return loss of the printed multi-band antenna 1 of the embodiment; FIG. 9 illustrates the VSWR of the printed multi-band antenna 1 of the embodiment; FIG. 10 illustrates the radiation efficiency of the printed multi-band antenna 1 of the embodiment; the first frequency is the operation frequency band of the first radiation body, and the second frequency is the operation frequency band of the second radiation body. According to FIG. 8, FIG. 9 and FIG. 10, after adjusted, all characteristics of the printed multi-band antenna 1 can completely satisfy the application requirements; besides, the return loss, VSWR and antenna radiation efficiency of the printed multi-band antenna can definitely conform the to regulations of the industry.

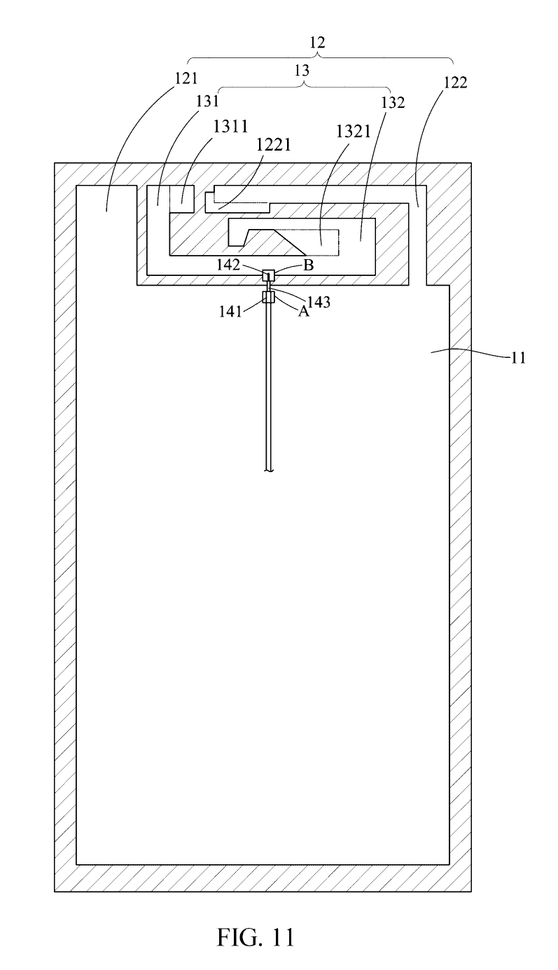

Please refer to FIG. 11, which is the schematic view of the eighth embodiment of the printed multi-band antenna in accordance with the present invention. As shown in FIG. 11, the printed multi-band antenna 1 may include a grounding area 11, a first radiation body 12 and a second radiation body 13. The difference between the embodiment and the previous embodiment is that the printed multi-band antenna shares the circuit board with the system, so its grounding area may be larger. As described above, the printed multi-band antenna 1 can not only be applied to an independent circuit board, but also can share a circuit board with the system, so the application of the printed multi-band antenna 1 can be more comprehensive.

In summation of the description above, in one embodiment of the present invention, the impedance matching, operation frequency band and bandwidth of the printed multi-band antenna are very easy to adjust, so the printed multi-band antenna can conform to the requirements of various applications. Thus, the printed multi-band antenna is very flexible in use. In one embodiment of the present invention, the printed multi-band antenna can be directly printed on a circuit board and the structure of the printed multi-band antenna is very simple, so the cost of the printed multi-band antenna can be lower. Besides, in one embodiment of the present invention, the printed multi-band antenna can directly feed the signals in the circuit board without additional cables, so the cost of the printed multi-band antenna can be further reduced. Moreover, in one embodiment of the present invention, the printed multi-band antenna does not need the grounding end, so the size of the printed multi-band antenna can be much smaller than planar inverse-F antenna. Furthermore, in one embodiment of the present invention, the printed multi-band antenna can use an independent circuit board, or share a circuit board with the system, so the application of the printed multi-band antenna can be more comprehensive.

While the means of specific embodiments in present invention has been described by reference drawings, numerous modifications and variations could be made thereto by those skilled in the art without departing from the scope and spirit of the invention set forth in the claims. The modifications and variations should in a range limited by the specification of the present invention.

What is claimed is:

1. A printed multi-band antenna, comprising:
a grounding area, being coupled to a grounding layer of a RF cable and the RF cable being coupled to a RF signal module;
a first radiation body, being coupled to the grounding area, wherein the first radiation body comprises a first left branch and a first right branch; the first left branch is disposed at one side of a joint between the RF cable and the grounding area; the first right branch is disposed at the other side of the joint between the RF cable and the grounding area; a space is formed between the first radiating body and the grounding area; and
a second radiation body, being disposed at the space, and coupled to a signal wire of the RF cable, wherein the second radiation body comprises a second left branch and a second right branch; the second left branch is disposed at one side of a joint of the RF cable and the second radiating body and the second right branch is disposed at the other side of the joint of the RF cable and the second radiating body.

2. The printed multi-band antenna of claim 1, wherein the first left branch is asymmetrical to the first right branch and the second left branch is asymmetrical to the second right branch.

3. The printed multi-band antenna of claim 1, wherein the first left branch extends vertically and/or horizontally.

4. The printed multi-band antenna of claim 1, wherein the first left branch is substantially L-shaped.

5. The printed multi-band antenna of claim 3, wherein the first left branch further comprises at least one patch and the patch is rectangular, circular, elliptical, trapezoid, polygonal or irregular-shaped.

6. The printed multi-band antenna of claim 5, wherein the patch of the first left branch is related to an impedance matching of the first radiation body.

7. The printed multi-band antenna of claim 1, wherein the first right branch extends vertically and/or horizontally.

8. The printed multi-band antenna of claim 1, wherein the first right branch is substantially L-shaped.

9. The printed multi-band antenna of claim 7, wherein the first left branch further comprises at least one patch and the patch is rectangular, circular, elliptical, trapezoid, polygonal or irregular-shaped.

10. The printed multi-band antenna of claim 9, wherein the patch of the first right branch is disposed at an end of the first right branch and related to a bandwidth of the first radiation body.

11. The printed multi-band antenna of claim 1, wherein a length of the first right branch is related to an operation frequency band of the first radiation body.

12. The printed multi-band antenna of claim 1, wherein the second right branch extends vertically and/or horizontally.

13. The printed multi-band antenna of claim 1, wherein the second right branch is substantially U-shaped.

14. The printed multi-band antenna of claim 12, wherein the second right branch further comprises at least one patch and the patch is rectangular, circular, elliptical, trapezoid, polygonal or irregular-shaped.

15. The printed multi-band antenna of claim 14, wherein the patch of the second right branch is disposed at a center of the second right branch and related to a bandwidth of the second radiation body.

16. The printed multi-band antenna of claim 1, wherein a length of the second right branch is related to an operation frequency band of the second radiation body.

17. The printed multi-band antenna of claim 1, wherein the second left branch extends vertically and/or horizontally.

18. The printed multi-band antenna of claim 1, wherein the second left branch is substantially U-shaped.

19. The printed multi-band antenna of claim 17, wherein a length of the second left branch is related to an operation frequency band of the second radiation body and the second left branch further comprises at least one patch, and the patch is rectangular, circular, elliptical, trapezoid, polygonal or irregular-shaped.

20. The printed multi-band antenna of claim 19, wherein the patch of the second left branch is disposed at an end of the second left branch and related to an impedance matching of the second radiation body.
